(19) United States
(12) Patent Application Publication
(10) Pub. No.: US 2014/0111980 A1
(43) Pub. Date: Apr. 24, 2014

(54) VEHICLE POWER ADAPTER WITH LIGHTING DEVICE

(71) Applicant: LUCENT TRANS ELECTRONIC CO., LTD., New Taipi City (TW)

(72) Inventor: Chin-Hung CHENG, New Taipei City (TW)

(73) Assignee: LUCENT TRANS ELECTRONIC CO., LTD., New Taipei City (TW)

(21) Appl. No.: 13/655,886

(22) Filed: Oct. 19, 2012

(51) Int. Cl. F21L 4/00

(52) U.S. Cl. 362/183

(57) ABSTRACT

A vehicle power adapter with lighting device has a casing, a power connector, at least one output connector and a lighting circuit. The lighting circuit is mounted in the casing and has a transforming circuit, a battery, an LED light and a switch. The switch connects between the LED light and the battery. A user turns the LED light on or off by operating the switch to switch on or off a connection between the LED light and the battery. The LED light can still work even though the vehicle power adapter is not plugged into a cigarette lighter socket because the battery of the lighting circuit powers the LED light. The vehicle power adapter can be used as a flashlight to provide auxiliary lighting in the vehicle.

### BACKGROUND OF THE INVENTION

1. Field of the Invention

The present invention relates to a vehicle power adapter, and more particularly to a vehicle power adapter with lighting device.

2. Description of the Prior Arts

Portable electronic apparatuses, such as laptops, Personal Digital Assistant (PDA), smart phones or the like, are widely used today, and the portable electronic apparatuses have multiple functions combined together. However, more functions result in higher power consumption of the portable electronic apparatuses.

In order to charge the portable electronic devices on vehicles, vehicle power adapters are invented. The conventional vehicle power adapter has a power connector and an output connector. The power connector is used to connect to a cigarette lighter socket to obtain vehicle power from a storage battery on the vehicle. The output connector is connected to the portable electronic device. The vehicle power adapter transforms the vehicle power to device power and provides the device power to and charges the connected portable electronic device.

However, even though the vehicle often has interior vehicle light sources to provide illumination inside the vehicle, it is still difficult to see things well enough either on or under seats if small objects, such as a key or a coin, are dropped on or under the seats when driving in the vehicle at night.

To overcome the shortcomings, the present invention provides a vehicle power adapter with lighting device to mitigate or obviate the aforementioned problems.

### SUMMARY OF THE INVENTION

The main objective of the invention is to provide a vehicle power adapter with lighting device to provide auxiliary lighting in vehicles. The vehicle power adapter with lighting device has a casing, a power connector, at least one output connector and a lighting circuit. The casing has a power end and an output end. The power connector is mounted telescopically in the power end of the casing. The at least one output connector is mounted in the output end of the casing. The lighting circuit is mounted in the casing, electronically connects to the power connector and the at least one output connector, and has a transforming circuit, a battery, an LED light and a switch. The transforming circuit electronically connects to the power connector and the at least one output connector. The LED light electrically connects to the battery and emits light out of the casing. The switch connects between the LED light and the battery and selectively actuates the LED light.

The power connector protrudes out of the power end of the casing to be plugged into a cigarette lighter socket in a vehicle to provide the functions as a vehicle power adapter. When interior vehicle light sources in the vehicle provide insufficient illumination inside the vehicle to see things well enough, the vehicle power adapter can be used as a flashlight to provide auxiliary lighting in the vehicle after pushing the telescopic power connector in the casing and actuating the switch.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a vehicle power adapter with lighting device in accordance with the present invention;

FIG. 2 is an exploded rear perspective view of the vehicle power adapter with lighting device in FIG. 1;

FIG. 3 is a side view in partial section of the vehicle power adapter with lighting device in FIG. 1;

FIG. 4 is an operational perspective view of the vehicle power adapter with lighting device in FIG. 1, showing the power connector protruding;

FIG. 5 is an operational side view in partial section of the vehicle power adapter with lighting device in FIG. 1, showing the power connector protruding;

FIG. 6 is a function diagram of the transforming circuit of the vehicle power adapter with lighting device in FIG. 1; and

FIG. 7 is a function diagram of the switch of the vehicle power adapter with lighting device in FIG. 1.

### DETAILED DESCRIPTION OF THE PREFERRED EMBODIMENTS

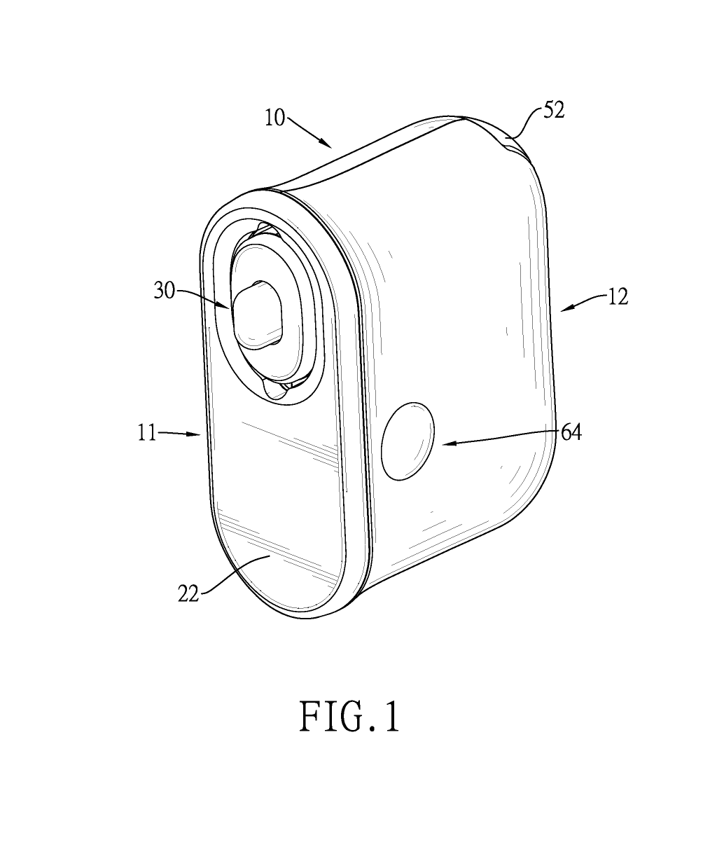

With reference to FIGS. 1 to 3, a vehicle power adapter with lighting device in accordance with the present invention comprises a casing 10, a power connector 30, at least one output connector 40 and a lighting circuit 60. In a preferred embodiment, the vehicle power adapter further comprises a battery seat 21, a transparent cover 22, a first resilient element 51, a pusher 52 and a second resilient element 53.

The casing 10 has a power end 11 and an output end 12. In a preferred embodiment, the casing 10 further has an opening slot 13. The opening slot 13 is formed through a sidewall between the power end 11 and the output end 12.

The battery seat 21 is detachably mounted in the opening slot 13 of the casing 10.

The transparent cover 22 is mounted on and covers the power end 11 of the casing 10.

The power connector 30 is mounted telescopically in the power end 11 of the casing 10. In a preferred embodiment, the power connector 30 is mounted through the transparent cover 22. The power connector 30 has an abutment segment 31 formed annularly around an outer surface of the power connector 30 and formed near an inner end of the power connector 30.

The at least one output connector 40 is mounted in the output end 12 of the casing 10. In a preferred embodiment, two output connectors 40 are implemented and are of universal serial bus type.

The first resilient element 51 is mounted in the casing 10 and is pressed between the power connector 30 and an inner surface of the casing 10. In a preferred embodiment, the first resilient element 51 is a spring and is mounted around the inner end of the power connector 30. Two ends of the first resilient element 51 respectively abut the inner surface of the casing 10 and the abutment segment 31 of the power connector 30.

The pusher 52 is moveably mounted through a sidewall of the casing 10 and selectively holds the power connector 30 in position. An inner end of the pusher 52 selectively engages the inner end of the power connector 30.

The second resilient element 53 is mounted in the casing 10 and is pressed between the pusher 52 and the inner surface of the casing 10. In a preferred embodiment, the second resilient element 53 is a spring.

With reference to FIGS. 1 to 3 and 6, the lighting circuit 60 is mounted in the casing 10 and electronically connects to the power connector 30 and the output connectors 40. The lighting circuit 60 has a transforming circuit 61, a battery 62, an LED light 63 and a switch 64.

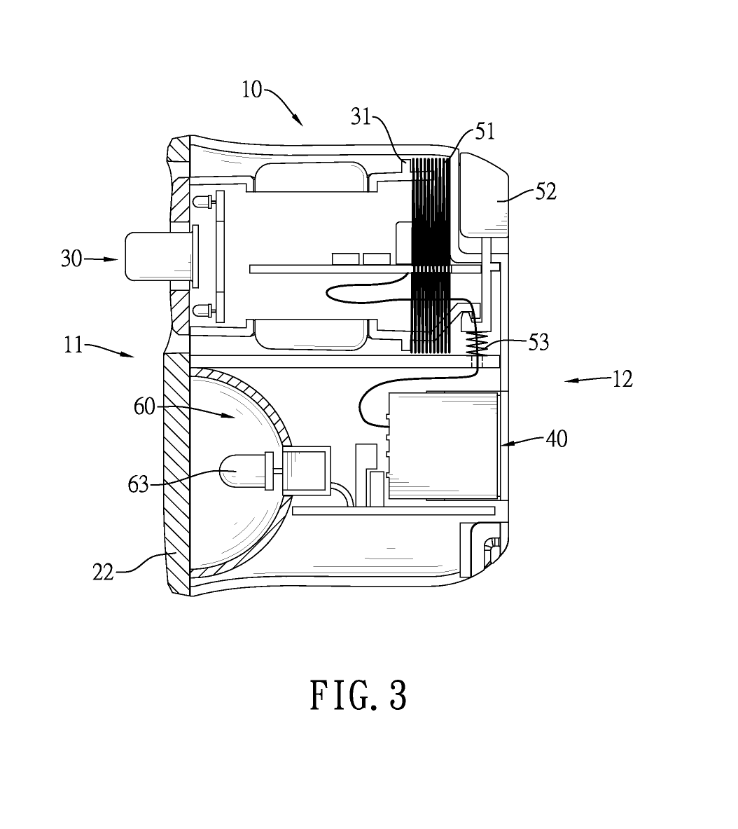

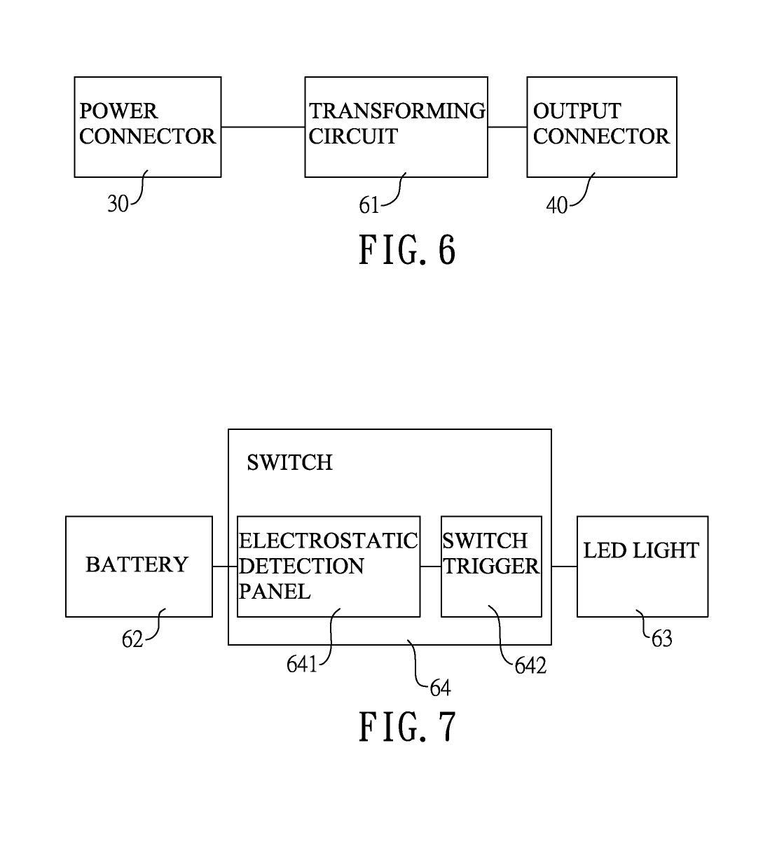

With reference to FIGS. 3 and 6, the transforming circuit 61 is mounted in the casing 10 and electronically connects to the power connector 30 and the output connectors 40, transforms vehicle power to device power, and outputs the device power to the output connectors 40. The device power is suitable for charging portable electronic devices.

With reference to FIGS. 1 to 3, the battery 62 is mounted in the casing 10. In a preferred embodiment, the battery 62 is removably mounted on the battery seat 21.

The LED light 63 is mounted in the casing 10, electrically connects to the battery 62 and emits light out of the casing 10. In a preferred embodiment, the LED light 63 emits light toward the transparent cover 22 such that the transparent cover 22 scatters the light emitted from the LED light 63.

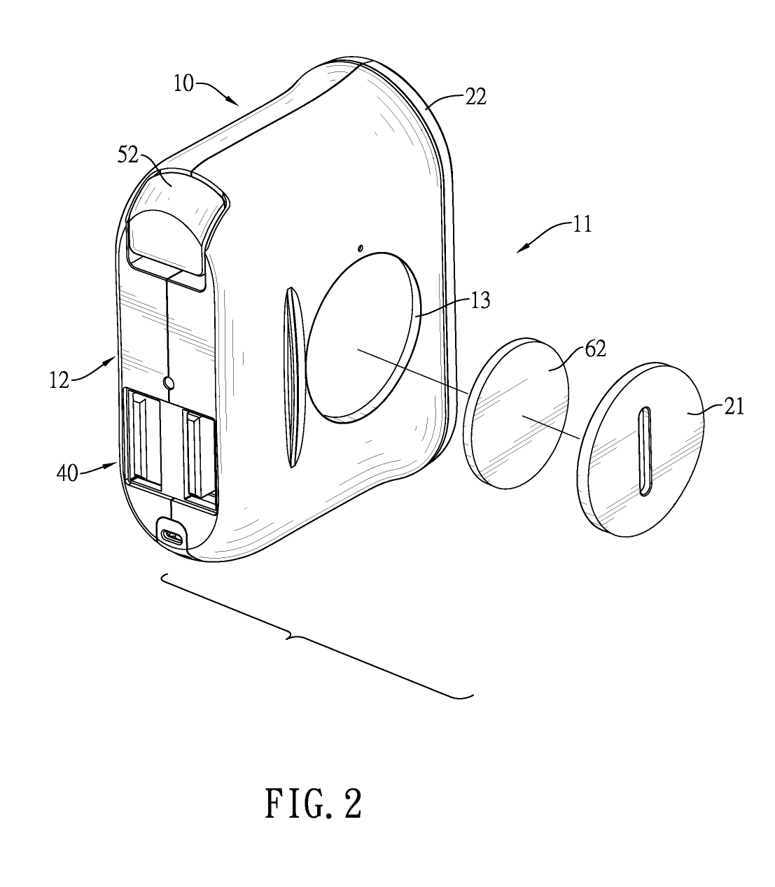

With reference to FIGS. 2, 3 and 7, the switch 64 is mounted in the casing 10, connects between the LED light 63 and the battery 62, and selectively actuates the LED light 63. In a preferred embodiment, the switch 64 has an electrostatic detection panel 641 and a switch trigger 642. The electrostatic detection panel 641 contacts the inner surface of the casing 10 and outputs a control signal when a user touches the outer surface of the casing 10 at points corresponding to where the inner surface is contacted by the electrostatic detection panel 641. The switch trigger 642 connects to the electrostatic detection panel 641 and actuates the switch 64 when receiving the control signal output from the electrostatic detection panel 641.

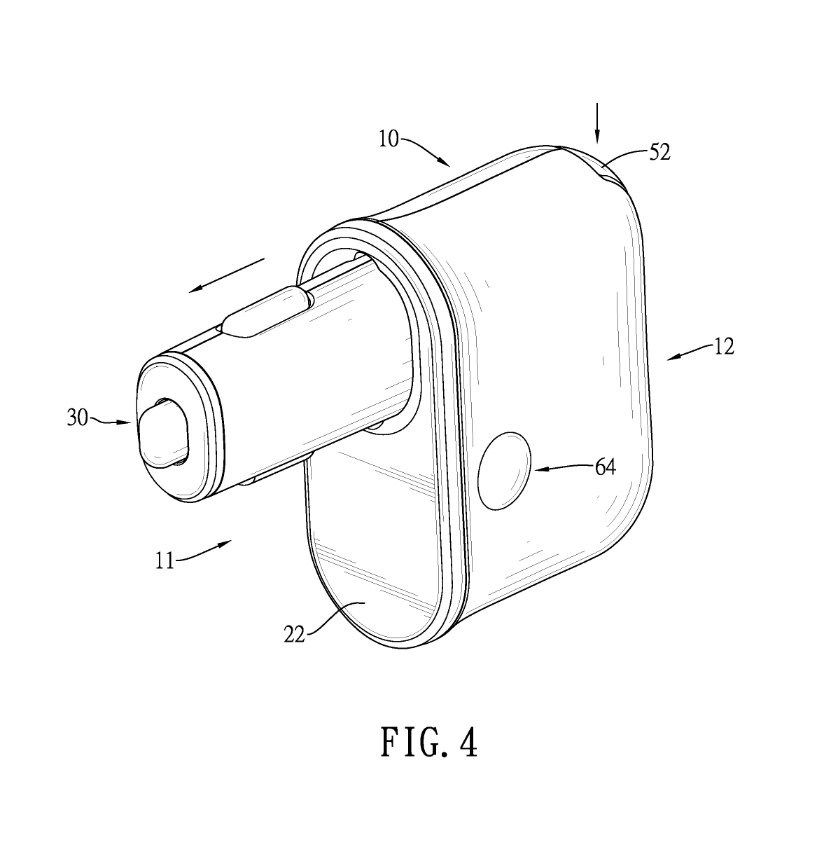

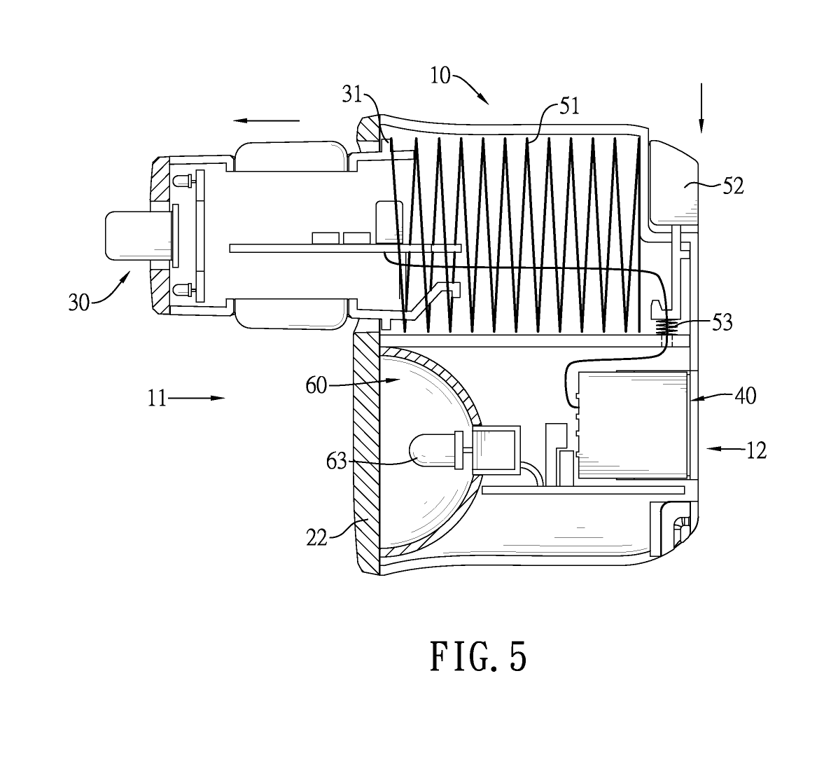

With reference to FIGS. 4 to 6, when the vehicle power adapter with lighting device as described is connected to a vehicle, the pusher 52 is pushed down. The inner end of the pusher 52 disengages from the inner end of the power connector 30 so that the power connector 30 is pushed out of the power end 11 of the casing 10 by the first resilient element 51. Then the power connector 30 is plugged into the cigarette lighter socket in the vehicle, and a portable electronic device can be connected to the output connector 40. The transforming circuit 61 transforms the vehicle power to device power and provides the device power to and charges the portable electronic device connected to the output connector 40.

With reference to FIGS. 1 to 3 and 7, when the vehicle power adapter as described is used as a flashlight, the power connector 30 is retracted into the casing 10. The first resilient element 51 is compressed by the moving power connector 30, and the power connector 30 is moved to engage the inner end of the pusher 52 again. The pusher 52 is pushed to the original position by the second resilient element 53 so that the pusher 52 can engage the inner end of the power connector 30. Thus the power connector 30 is held in the casing 10. Then the user touches the outer surface of the casing 10 at points corresponding to where the inner surface is contacted by the electrostatic detection panel 641, and electrostatic charges are generated by the user's skin. The electrostatic detection panel 641 outputs a control signal corresponding to the electrostatic charges. The switch trigger 642 actuates the switch 64 when receiving the control signal output from the electrostatic detection panel 641 and then the LED light 63 is turned on to provide auxiliary lighting in the vehicle.

Besides, the LED light 63 can still be switched on by the same means when the power connector 30 is not retracted into the casing 10. In addition, when the vehicle power adapter is not plugged into the cigarette lighter socket, the LED light 63 can still be switched on by the battery 62.

Moreover, the switch trigger 642 turns the switch 64 off when the user's finger leaves the touch points corresponding to where the electrostatic detection panel 641 is located.

To sum up, the vehicle power adapter with lighting device as described can be used as a vehicle power adapter to transform the vehicle power to charge the portable electronic device, and also can be used as a flashlight to provide auxiliary lighting in the vehicle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vehicle power adapter with lighting device comprising:
a casing having a power end and an output end;
a power connector mounted telescopically in the power end of the casing;
at least one output connector mounted in the output end of the casing; and
a lighting circuit mounted in the casing, electronically connecting to the power connector and the at least one output connector, and having
a transforming circuit mounted in the casing and electronically connecting to the power connector and the at least one output connector;
a battery mounted in the casing;
an LED light mounted in the casing, electrically connecting to the battery and emitting light out of the casing; and
a switch mounted in the casing, connecting between the LED light and the battery, and selectively actuating the LED light.

2. The vehicle power adapter as claimed in claim 1 further comprising a first resilient element mounted in the casing and pressed between the power connector and an inner surface of the casing.

3. The vehicle power adapter as claimed in claim 2, wherein
the power connector has an abutment segment formed annularly around an outer surface of the power connector; and
the first resilient element is a spring, is mounted around the power connector and abuts the abutment segment.

4. The vehicle power adapter as claimed in claim 2 further comprising a pusher and a second resilient element, wherein
the pusher is moveably mounted through a sidewall of the casing and selectively holding the power connector in position;
an inner end of the pusher selectively engages an inner end of the power connector; and
the second resilient element is mounted in the casing and is pressed between the pusher and the inner surface of the casing.

5. The vehicle power adapter as claimed in claim 3 further comprising a pusher and a second resilient element, wherein
the pusher is moveably mounted through a sidewall of the casing and selectively holding the power connector in position;
an inner end of the pusher selectively engages an inner end of the power connector; and
the second resilient element is mounted in the casing and is pressed between the pusher and the inner surface of the casing.

6. The vehicle power adapter as claimed in claim 4, wherein the second resilient element is a spring.

7. The vehicle power adapter as claimed in claim 5, wherein the second resilient element is a spring.

8. The vehicle power adapter as claimed in claim 1 further comprising a battery seat, wherein
the casing further has an opening slot;
the battery seat is detachably mounted in the opening slot; and
the battery is removably mounted on the battery seat.

9. The vehicle power adapter as claimed in claim 7 further comprising a battery seat, wherein
the casing further has an opening slot;
the battery seat is detachably mounted in the opening slot; and
the battery is removably mounted on the battery seat.

10. The vehicle power adapter as claimed in claim 8, wherein the opening slot of the casing is formed through a sidewall between the power end and the output end.

11. The vehicle power adapter as claimed in claim 9, wherein the opening slot of the casing is formed through a sidewall between the power end and the output end.

12. The vehicle power adapter as claimed in claim 1 further comprising a transparent cover mounted on and covering the power end of the casing, wherein
the LED light emits light toward the transparent cover such that the transparent cover scatters the light emitted from the LED light; and
the power connector is mounted through the transparent cover.

13. The vehicle power adapter as claimed in claim 11 further comprising a transparent cover mounted on and covering the power end of the casing, wherein
the LED light emits light toward the transparent cover such that the transparent cover scatters the light emitted from the LED light; and
the power connector is mounted through the transparent cover.

14. The vehicle power adapter as claimed in claim 1, wherein the switch has
an electrostatic detection panel contacting an inner surface of the casing and outputting a control signal when a user touches an outer surface of the casing at points corresponding to where the inner surface is contacted by the electrostatic detection panel; and
a switch trigger connecting to the electrostatic detection panel and turning the switch on when receiving the control signal output from the electrostatic detection panel.

15. The vehicle power adapter as claimed in claim 13, wherein the switch has
an electrostatic detection panel contacting the inner surface of the casing and outputting a control signal when a user touches an outer surface of the casing at points corresponding to where the inner surface is contacted by the electrostatic detection panel; and
a switch trigger connecting to the electrostatic detection panel and turning the switch on when receiving the control signal output from the electrostatic detection panel.

16. The vehicle power adapter as claimed in claim 1, wherein the at least one output connector is implemented in universal serial bus type.

17. The vehicle power adapter as claimed in claim 15, wherein the at least one output connector is implemented in universal serial bus type.
